(19) United States
(12) Patent Application Publication
(10) Pub. No.: US 2022/0271389 A1
(43) Pub. Date: Aug. 25, 2022

(54) ASSEMBLED BATTERY

(71) Applicant: TOYOTA JIDOSHA KABUSHIKI KAISHA, Toyota-shi Aichi-ken (JP)

(72) Inventor: Yosuke Torazawa, Okazaki-shi Aichi-ken (JP)

(21) Appl. No.: 17/586,257

(22) Filed: Jan. 27, 2022

(30) Foreign Application Priority Data
Feb. 19, 2021 (JP) 2021-024779

(51) Int. Cl. H01M 50/342; H01M 50/502

(52) U.S. Cl. CPC H01M 50/3425; H01M 50/502

(57) ABSTRACT

An assembled battery includes a plurality of sealed batteries each including a safety valve such that the sealed batteries are electrically connected in series or in parallel to each other via bus bars. Each of the bus bars is placed to connect adjacent sealed batteries to each other via a part right above the safety valve of at least either one of the adjacent sealed batteries. The each of the bus bars is formed to break right above the safety valve by heat of gas when the gas blows out upward from the safety valve.

### CROSS-REFERENCE TO RELATED APPLICATION

This application claims priority to Japanese Patent Application No. 2021-024779 filed on Feb. 19, 2021, incorporated herein by reference in its entirety.

### BACKGROUND

### 1. Technical Field

The present disclosure relates to an assembled battery, and more particularly, to an assembled battery configured such that a plurality of sealed batteries each having a safety valve is connected to each other via bus bars.

### 2. Description of Related Art

In the related art, as such a type of assembled battery, there has been proposed an assembled battery having a structure in which a plurality of battery cells is connected in series to each other via bus bars or the like (e.g., see Japanese Unexamined Patent Application Publication No. 2005-322471 (JP 2005-322471 A)). Each of the battery cells includes a safety valve provided on its top face. The safety valve provided in each of the battery cells is constituted by metal foil and a break line. A lead wire to be cut when an internal pressure rises and the metal foil breaks along the break line is provided integrally with the metal foil constituting the safety valve. Hereby, the state of the safety valve of the cell is detected by a simple circuit.

### SUMMARY

However, the abovementioned assembled battery may cause the following case. That is, when gas blows out of the safety valve, a component such as a cell case melts such that the component is electrically connected to a container in which the battery cells are stored, thereby resulting in that a short circuit is formed in the assembled battery. In a case of a lithium-ion battery, gas blowing out from a safety valve reaches around 1000° C. and melts a component made of aluminum or the like. This might cause such a case that the aluminum thus melted runs down into a container in which battery cells are stored and a closed circuit is formed by an assembled battery and the container. In this case, heavy-current flows into the closed circuit. As a result, a hole might be formed in the container, and gas might be discharged to outside.

A main object of an assembled battery of the present disclosure is to avoid a closed circuit from being caused via a container when gas blows out from a safety valve.

In order to achieve the main object, the assembled battery of the present disclosure employs the following approach.

The assembled battery of the present disclosure is an assembled battery including a plurality of sealed batteries each including a safety valve, the sealed batteries being electrically connected in series or in parallel to each other via bus bars. Each of the bus bars is placed to connect adjacent sealed batteries to each other via a part right above the safety valve of at least either one of the adjacent sealed batteries. The each of the bus bars is formed to break right above the safety valve by heat of gas when the gas blows out upward from the safety valve.

In the assembled battery of the present disclosure, the bus bar is placed to connect adjacent sealed batteries to each other via a part right above the safety valve of at least either one of the adjacent sealed batteries. The bus bar is formed to break right above the safety valve by heat of gas when the gas blows out upward from the safety valve. Due to the breakage of the bus bar, it is possible to avoid a closed circuit from being formed even when a component melts by heat of the gas. As a result, it is possible to restrain a hole from being formed in a container due to heavy-current flowing into the closed circuit, thereby making it possible to restrain such a situation that gas blowing out is discharged to outside.

In the assembled battery of the present disclosure, the each of the bus bars may be formed to have a width equal to or less than a width of an outlet for the gas from the safety valve, right above the safety valve. With this configuration, it is possible to more surely break the bus bar. This accordingly makes it possible to more surely restrain a closed circuit from being formed when gas blows out upward from the safety valve.

In the assembled battery of the present disclosure, the each of the bus bars may be formed to bend right above the safety valve or near the safety valve. In this case, the bus bar may be formed in a “square-U” shape or a “V” shape.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a sectional view illustrating a plan section of an assembled battery 20 according to one embodiment of the present disclosure that is taken along a line A-A in FIG. 2;

FIG. 2 is a sectional view illustrating a plan section of the assembled battery 20 of the embodiment along a line B-B in FIG. 1;

FIG. 3 is an explanatory view illustrating a state at the time when gas blows out of a safety valve 36c of a battery cell 30c; and

FIG. 4 is a sectional view of an assembled battery 120 of a modification that corresponds to the plan section taken along the line A-A in FIG. 2.

### DETAILED DESCRIPTION OF EMBODIMENTS

Next will be described a mode for carrying out the present disclosure with reference to an embodiment.

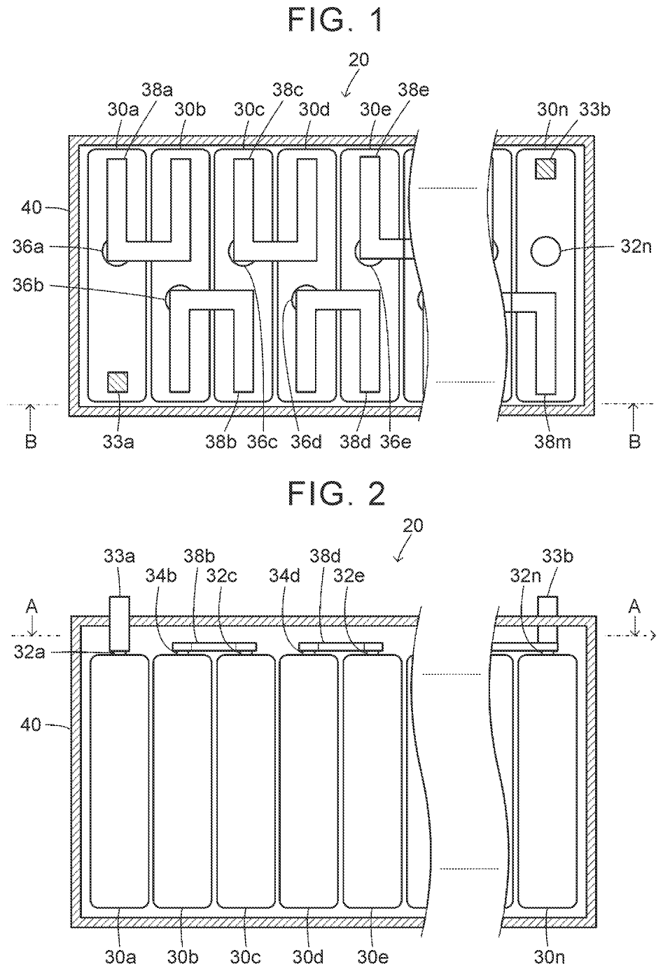

FIG. 1 is a sectional view illustrating a plan section of an assembled battery 20 according to one embodiment of the present disclosure that is taken along a line A-A in FIG. 2. As illustrated in FIGS. 1, 2, the assembled battery 20 of the embodiment includes a positive terminal 33a, a negative terminal 33b, n pieces of battery cells 30a to 30n, m pieces of bus bars 38a to 38m, and a case 40.

Each of the battery cells 30a to 30n is constituted as a sealed lithium-ion battery stored in a an aluminum can case, for example, and the battery cells 30a to 30n include respective positive electrodes 32a to 32n and respective negative electrodes 34a to 34n. Safety valves 36a to 36n are attached to the battery cells 30a to 30n, respectively, such that the safety valves 36a to 36n are placed at respective positions closer to the negative electrodes 34a to 34n from respective centers between the positive electrodes 32a to 32n and the negative electrodes 34a to 34n. The battery cells 30a to 30n are placed such that the positive electrodes and the negative electrodes of adjacent battery cells are arranged alternately, and the positive electrodes and the negative electrodes of the adjacent battery cells are connected in series via them pieces of bus bars 38a to 38m. The positive terminal 33a is attached to the positive electrode 32a of the battery cell 30a, and the negative terminal 33b is attached to the negative electrode 34n of the battery cell 30n.

The bus bars 38a to 38m are made of aluminum in a “square-U” shape, for example, such that respective first bending portions are placed right above the safety valves 36a to 36m. The bus bars 38a to 38m are formed with widths equal to or less than widths of respective gas outlets of gas from the safety valves so that parts of the bus bars 38a to 38m that are placed right above the safety valves 36a to 36m break when gas blows out from the inside of the battery cells via the safety valves. Accordingly, when any of the battery cells 30a to 30n has an abnormality, and high-temperature gas blows out from the battery cell through its safety valve, a part of the bus bar that is placed right above the safety valve melts due the high-temperature gas, so that the bus bar breaks.

The case 40 is made of aluminum or the like, for example, and the n pieces of battery cells 30a to 30n are stored in the case 40. Respective through-holes through which the positive terminal 33a and the negative terminal 33b are led to outside are formed at corners (a left lower corner and a right upper corner in FIG. 1) on a generally diagonal line of an upper part of the case 40.

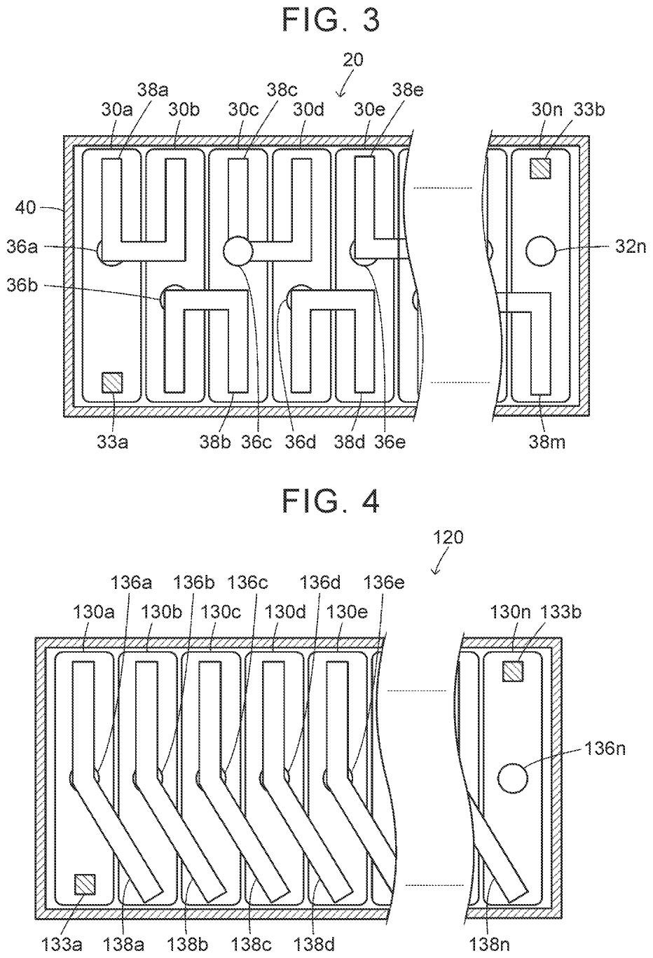

FIG. 3 is an explanatory view illustrating a state where gas blows out from the safety valve 36c of the battery cell 30c (the third battery cell from the left in FIG. 3). When some abnormality occurs in the battery cell 30c and gas blows out from the safety valve 36c, a part of the bus bar 38c that is placed right above the safety valve 36c melts, so that the bus bar 38c breaks. The bus bar 38c connects the negative electrode 34c of the battery cell 30c to the positive electrode 32d of the battery cell 30d. This might cause such a case that the bus bar 38c or other components melt and run down into the case 40 along with the blowout of the gas from the battery cell 30c, and the battery cell 30c is electrically connected to the case 40. However, since the bus bar 38c breaks, it is possible to restrain an electrically closed circuit from being formed by the assembled battery 20 and the case 40.

In the assembled battery 20 of the embodiment described above, the negative electrodes and the positive electrodes of adjacent battery cells among the battery cells 30a to 30n are connected by the bus bars 38a to 38m via respective parts of the bus bars 38a to 38m that are right above the safety valves 36a to 36m. Accordingly, even when any of the battery cells 30a to 30n has an abnormality and gas blows out from its safety valve, it is possible to break, by the gas thus blowing out, the bus bar via which the negative electrode of the battery cell having the abnormality is connected to the positive electrode of its adjacent battery cell. Hereby, even in a case where the bus bar or other components melt and run down into the case 40 along with the blowout of the gas from the battery cell such that the assembled battery 20 is electrically connected to the case 40, the breakage of the bus bar can restrain such a situation that an electrically closed circuit is formed by the assembled battery 20 and the case 40. As a result, it is possible to restrain such a situation that a hole is formed in the case 40 due to heavy-current flowing into the closed circuit, thereby making it possible to restrain gas from leaking outside the case 40.

In the assembled battery 20 of the embodiment, the battery cells 30a to 30n are placed such that the positive electrodes and the negative electrodes of adjacent battery cells are arranged alternately, and the positive electrodes and the negative electrodes of the adjacent battery cells are connected in series via the m pieces of bus bars 38a to 38m having a “square-U” shape. However, the n pieces of battery cells placed in the same manner may be connected such that the positive electrodes and the negative electrodes of the adjacent battery cells are connected in series via m pieces of bus bars having a “U” shape.

Further, as illustrated in an assembled battery 120 of a modification in FIG. 4, battery cells 130a to 130n may be placed such that the positive electrodes of adjacent battery cells are arranged in line, and the positive electrodes and the negative electrodes of the adjacent battery cells are connected in series via m pieces of bus bars 138a to 138m. In this case, the m pieces of bus bars 138a to 138m may be formed in a “V” shape such that the bus bars 138a to 138m are extended from negative electrodes 134a to 134m of the battery cells 130a to 130m to safety valves 136a to 136m of the battery cells 130a to 130m, then bent right above the safety valves 136a to 136m, and further extended to positive electrodes 132b to 132n of their adjacent battery cells 130b to 130n so that that the negative electrodes 134a to 134m are connected to the positive electrodes 132b to 132n, respectively. Note that, even in this case, respective widths of the bus bars 138a to 138m should be formed to be equal to or less than respective widths of outlets for gas from the safety valves 136a to 136m so that the bus bars 138a to 138m break due to heat of the gas when the gas blows out from the safety valves 136a to 136m.

In the assembled battery 20 of the embodiment, the battery cells 30a to 30n are configured as lithium-on batteries but may be configured as other types of cells.

In the assembled battery 20 of the embodiment, the battery cells 30a to 30n are connected in series to each other but may be partially or fully connected in parallel to each other.

The following describes a correspondence between main elements of the embodiment and main elements of the present disclosure described in the field of SUMMARY. In the present embodiment, the safety valves 36a to 36n correspond to the “safety valves,” the battery cells 30a to 30n correspond to the “sealed batteries,” the bus bars 38a to 38m corresponds to the “bus bars,” and the assembled battery 20 corresponds to the “assembled battery.”

Note that, since the embodiment is an example to specifically describe a mode for carrying out the present disclosure described in the field of SUMMARY, the correspondence between the main elements of the embodiment and the main elements of the present disclosure described in the field of SUMMARY does not limit the elements of the present disclosure described in the field of SUMMARY. That is, the present disclosure described in the field of SUMMARY should be interpreted based on the description of the field, and the embodiment is just a concrete example of the present disclosure described in the field of SUMMARY.

The mode for carrying out the present disclosure has been described with reference to the embodiment, but it is needless to say that the present disclosure is not limited to the above embodiment at all and may be performable in various embodiments as long as the various embodiments are not beyond the gist thereof.

The present disclosure is usable in a manufacture industry of an assembled battery or the like.

What is claimed is:

1. An assembled battery including a plurality of sealed batteries each including a safety valve, the sealed batteries being electrically connected in series or in parallel to each other via bus bars, wherein:
each of the bus bars is placed to connect adjacent sealed batteries to each other via a part right above the safety valve of at least either one of the adjacent sealed batteries; and
the each of the bus bars is formed to break right above the safety valve by heat of gas when the gas blows out upward from the safety valve.

2. The assembled battery according to claim 1, wherein the each of the bus bars is formed to have a width equal to or less than a width of an outlet for the gas from the safety valve, right above the safety valve.

3. The assembled battery according to claim 1, wherein the each of the bus bars is formed to bend right above the safety valve or near the safety valve.
